(19) United States
(12) Patent Application Publication
(10) Pub. No.: US 2002/0046266 A1
(43) Pub. Date: Apr. 18, 2002

(54) Computer-implemented method and apparatus for the cloning of input/output devices

(76) Inventors: Kurudi H. Muralidhar, Novi, MI (US); Pranav Shah, Ypsilanti, MI (US); Bryan Bridges, Grosse Ile, MI (US)

Correspondence Address: HARNESS, DICKEY & PIERCE, P.L.C., P.O. BOX 828, BLOOMFIELD HILLS, MI, 48303, US

(21) Appl. No.: 09/925,937

(22) Filed: Aug. 9, 2001

Related U.S. Application Data
(60) Provisional application No. 60/224,088, filed on Aug. 9, 2000.

(51) Int. Cl. G06F 15/177

(52) U.S. Cl. 709/220

(57) ABSTRACT

A system for cloning input/output (I/O) devices connected to a network hosting an industrial control system includes a first network coupled to a second network. A first plurality of I/O devices are connected to the first network. A second plurality of I/O devices are connected to the second network. A master computer is coupled to one of the first and second networks and includes control software with an object oriented model for defining attributes and operations of the I/O devices on the first network to allow cloning of the I/O devices onto the second network. The object oriented model includes a hierarchical class structure with inheritance. The hierarchical class structure includes a device class and a plurality of device types. The object oriented model includes at least one class level hierarchically below the device class. Devices instantiated at a class level inherit the attributes or operations of the class level.

### CROSS-REFERENCE TO RELATED APPLICATIONS

This application claims the benefits of U.S. Provisional Application Ser. No. 60/224,088, filed Aug. 9, 2000.

### FIELD OF THE INVENTION

The present invention relates generally to control systems, and more particularly to industrial input/output (I/O) networks and devices.

### BACKGROUND OF THE INVENTION

Industrial control systems are generally used for controlling processes that involve input/output (I/O) devices such as relays, solenoids, motors, valves, switches, and other electrical and electromechanical devices. The processes that are controlled include machining, drilling, welding, spraying paint, mixing materials, assembling parts, handling materials, etc.

There are several different types of industrial control systems. Some conventional programming and control systems use ladder diagrams and relay ladder logic (RLL) to control the operation of the I/O devices associated with the processes. In practice, however, programmers tend to use a flowchart to initially define the operation of the I/O devices in the process. Then, the programmers manually translate the flowchart into the ladder diagrams. The programmers employ the flowcharts as a first step because the flowcharts emulate human thought processes whereas the ladder diagrams do not. Some later-developed industrial control systems allow the designer to create flowcharts on a computer using a graphical user interface. These systems automatically generate the control logic from the flowchart. One flowchart-based system is disclosed in “Continuous Flowchart, Improved Data Format and Debugging System For Programming and Operation of Machines”, U.S. Pat. No. 4,852,047, which is hereby incorporated by reference.

A significant problem encountered with both flowchart-based and RLL-based programs is the entry of parameters and other values for each of the I/O devices that are connected to the industrial control system. A process may include only a few I/O devices or may include hundreds of I/O devices. Each I/O device may have over 100 attributes. For example, a motor starter may have current and voltage limit attributes. Prior approaches have used time-consuming ways to configures the networked devices, such as requiring the manual entry of the name, attributes and/or parameters for each I/O device.

### SUMMARY OF THE INVENTION

A system for cloning input/output (I/O) devices that are connected to a network of an industrial control system includes a first network coupled to a second network. A first plurality of I/O devices are connected to the first network. A second plurality of I/O devices are connected to the second network. A master computer is coupled to one of the first and second networks. The master computer includes control software with an object oriented model for defining attributes or parameters of the I/O devices on the first network to allow cloning of the I/O devices on the second network.

In other features of the invention, the object oriented model includes a hierarchical class structure with inheritance. The hierarchical class structure includes a device class and a plurality of device types. The object oriented model includes at least one class level hierarchically below the device class.

In still other features of the invention, the I/O devices instantiated at a class level inherit the attributes or parameters of the class level. The control software includes a graphical user interface for interfacing the control software and cloning the I/O devices. The I/O devices include barcode readers, sensors, actuators, motor starters and other similar devices.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a network diagram depicting network A coupled to network B and a master computer;

FIG. 2 illustrates an object-oriented model and classes that are used to clone I/O devices;

FIG. 3 is a flowchart illustrating operational steps for cloning the I/O devices;

FIG. 4 illustrates a graphical user interface (GUI) for selecting a device object that will be cloned to create new device objects;

FIG. 5 illustrates a GUI for an exemplary device object that allows attributes or parameters to be set;

FIG. 6 illustrates a GUI for configuring parameters for a first device object;

FIG. 7 illustrates cloning of the first I/O device;

FIG. 8 illustrates a network neighborhood GUI of the master computer;

FIG. 9 illustrates a GUI showing target systems that are auto-discovered; and

FIG. 10 illustrates a GUI that enables cloning of the I/O devices of the target systems and modification of the attributes or parameters of the I/O devices.

### DETAILED DESCRIPTION OF THE PREFERRED EMBODIMENTS

The following description of the preferred embodiment(s) is merely exemplary in nature and is in no way intended to limit the invention, its application, or uses.

The present invention uses an object oriented model for specifying and configuring industrial input/output (I/O) networks and devices. The unique object oriented model of the present invention allows greater ease and flexibility for specifying attributes or properties of different I/O devices that are connected to the networks. The object oriented model is used to automatically clone devices, their attributes or properties. The present invention provides a powerful mechanism—particularly in situations where the industrial I/O network and devices are configured off-line.

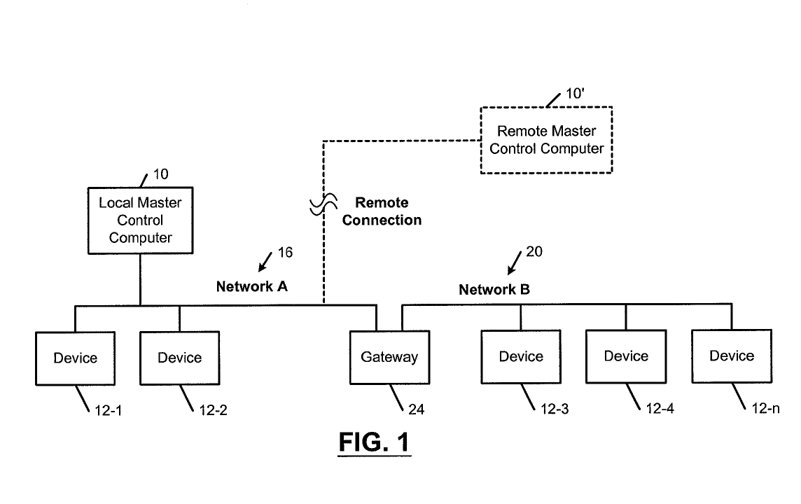

Referring now to FIG. 1, a network diagram depicts a local master control computer 10 or a remote master computer 10′ that is connected to an I/O device 12-1 and an 1/O device 12-2 via a network A 16. A network B 20 is connected to the network A 16 through a gateway 24. The network A 16 and the network B 20 can be similar or different types of networks. Additional devices (e.g., device 12-3, . . . 12-n) are connected to the network B 20.

For example in a first exemplary system, the network A 16 is an Ethernet network and the network B 20 is a Honeywell proprietary network. Still other network types are contemplated and may be employed without departing from the present invention. The master control computer 10 and/or 10′ is a computer running Microsoft® Windows®. The I/O devices 12 include but are not limited to: RF (radio frequency) barcode readers; sensors (e.g., temperature sensors); actuators (e.g., relays); motor starters; and other industrial I/O devices.

One existing problem (that the present invention overcomes) is the difficulty in configuring multiple I/O devices 12 that exist on multiple networks. For example, a factory may have 168 motor starters on one or more interconnected networks. Each motor starter may have over 100 attributes and/or properties. Examples of motor starter attributes include a current and voltage limits. Prior approaches have used time-consuming ways to configure the characteristics of the networked devices 12.

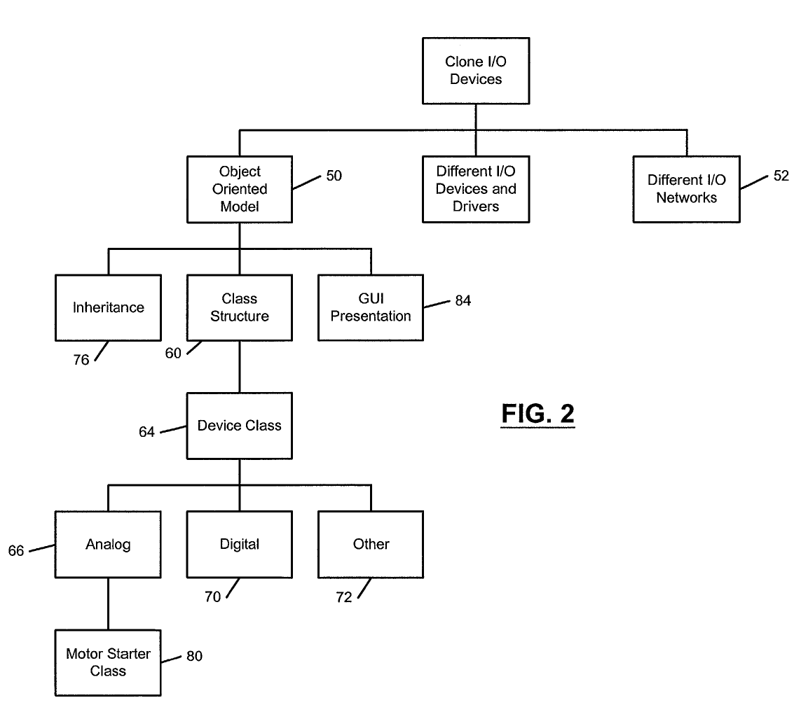

As is shown in FIG. 2, the present invention uses an object oriented model 50 to clone the I/O devices 12, including the I/O devices 12 that are on different I/O networks 52. Industrial devices are expressed in the control software on the master control computer 10 and/or 10′ using an object oriented model 50 according to the present invention. The object oriented model 50 creates a class structure that includes a device class 64.

As a non-limiting example, the device class includes an analog class 66, a digital class 70, and other related device classes 72. Through a property of inheritance 76, the I/O devices 12 that are instantiated from the analog class 66 automatically inherit the attributes, properties and/or operations of the analog class 66. Thus, the user does not have to retype attributes and perform initialization operations as each I/O device object is created (or cloned).

Furthermore, classes inherit from other classes. For example, a motor starter class 80 may be created as a subclass of the analog class 66. Objects that are instantiated from the motor starter class 80 have all of the attributes and operations of the motor starter class 80 as well as those from the analog class 66. Thus, a motor starter object has automatically (without need for additional user data entry) the current and voltage limit attributes as well as many other attributes of the motor starter class 80 and the analog class 66.

The object oriented model 50 of the present invention presents the same type of graphical user interface (GUI) 84 to the user irrespective of what device objects are being created and on what network. Thus, the same GUI 84 is used to create device objects for a motor starter device object as for a temperature sensor device object.

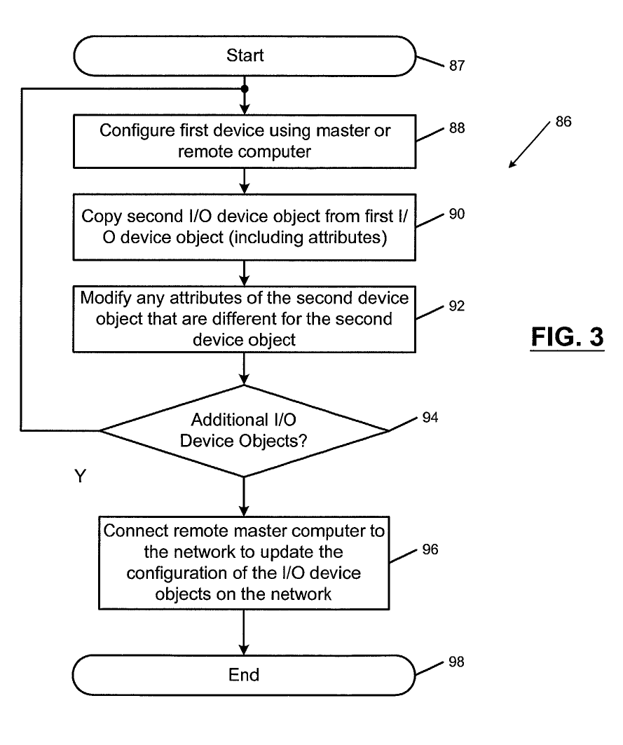

Referring now to FIG. 3, a flowchart 86 shows the operational steps for the present invention. In step 87, control starts. In step 88, the user configures a first I/O device in order to set the attributes of the first I/O device. In step 90, the user makes a copy of the second I/O device from the first I/O device. In the preferred embodiment, an object copy operation is performed by right mouse clicking on the first I/O device object in order to make a copy of the second I/O device object from the first I/O device object. In step 92, the attribute values of the second I/O device object are modified if desired. In step 94, if other I/O device objects need to created, control continues with step 88.

The user can perform steps 1-3 either at the site of the local master control computer 10 or at a computer that is remote from the industrial site (this is shown respectively in FIG. 1 as the local master control computer 10 or the optional remote master control computer 10′). Preferably, the configuration is performed off-line. In other words, the master computer 10 and/or 10′ is not connected to the network since a network connection typically slows down the configuration process. The remote site configuration of the I/O devices 12 has significant advantages since the configuration can be performed by control software engineers at their own location and then electronically sent to the industrial site. The user can also do the configuration of the first I/O device 12 and of the other I/O devices on-line at the industrial site.

In step 96 in FIG. 3, the user connects the master computer 10 or 10′ to the network in order to send the created device objects to the proper devices that are on the network. In this way, the software on the network I/O devices are updated with the newly created device objects. The newly created I/O device objects then operate in accordance with the attributes and operations of the newly created device objects. Control ends with step 98.

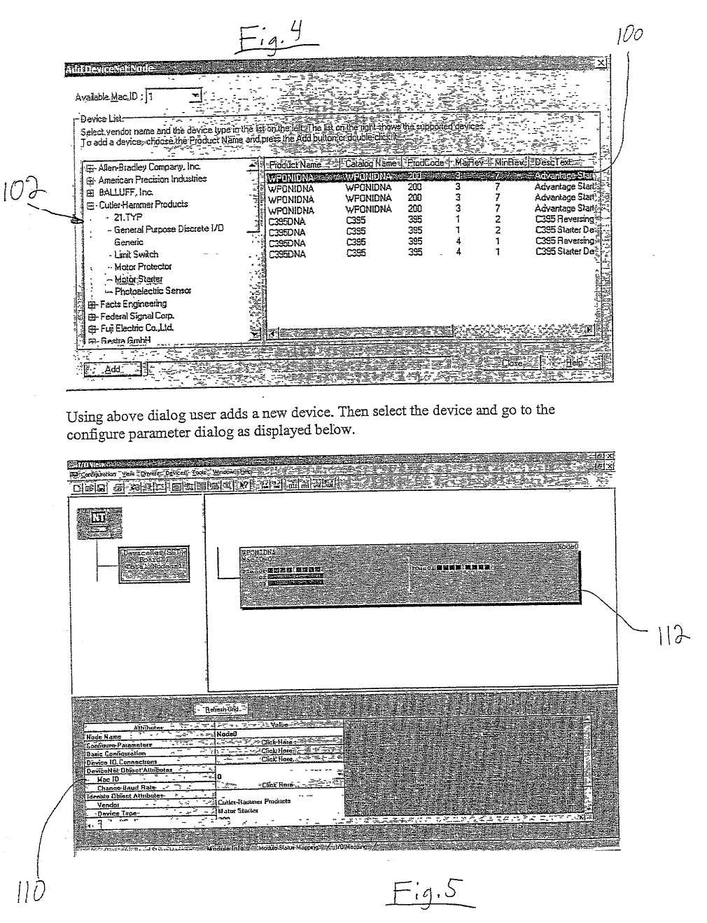

FIG. 4 shows a GUI wherein the user uses a dialog window to select a new I/O device object from which other I/O device objects are to be cloned. The user highlights (as shown by reference 100) the I/O device object that is desired to be cloned. In the preferred embodiment, the GUI presents at reference numeral 102 the I/O devices in a hierarchical fashion, such as but not limited to, having at the top of the hierarchy the manufacturer's name followed by different device types. The hierarchical arrangement allows the user to more quickly locate desired I/O device objects.

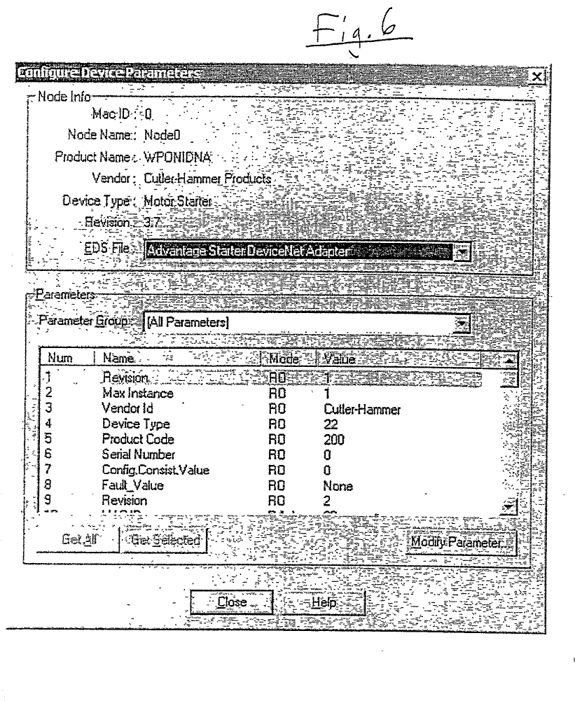

FIG. 5 is a computer screen showing that a motor starter object has been selected and displays the attributes and values of the object as shown by reference numeral 110. The input and output characteristics of the object are shown by reference numeral 112.

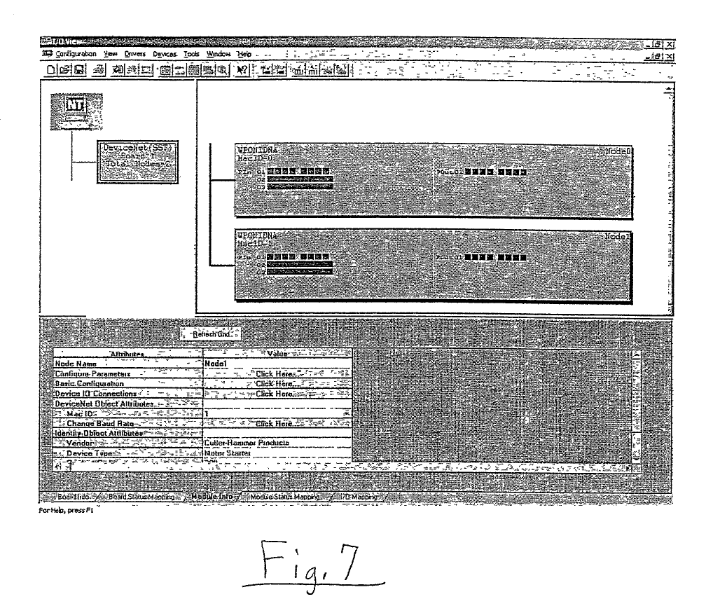

FIG. 6 is a computer screen that is used to configure the attributes (i.e., parameters) for a first device object. Once the user has completed the configuration, the user saves the configuration. To add another device object to the configuration that is identical to the first I/O device object, the user selects the first I/O device object and executes an object copy command. This command gets the address for the new device from the user and configures all of the parameters automatically from the selected first device object as can be seen in FIG. 7.

The present invention also uses an object oriented model to automatically discover the target control platforms based Windows NT/2000 or WindowsCE systems and Input/Output devices. Further, in the case of Input/Output Devices, the object model once discovered, specifies and configures the devices. This model will be used to automatically clone the Input/Output devices and set their attributes and properties.

The present invention uses the Microsoft, Novell, and Vendor Specific protocols to automatically discover the target systems and devices. Once the target system is identified, the object model is used to set the attributes and properties of the control application running in the target system.

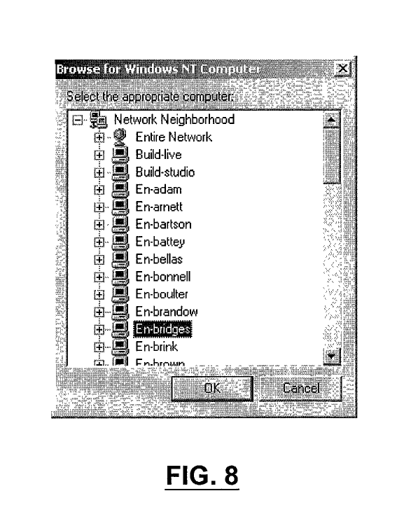

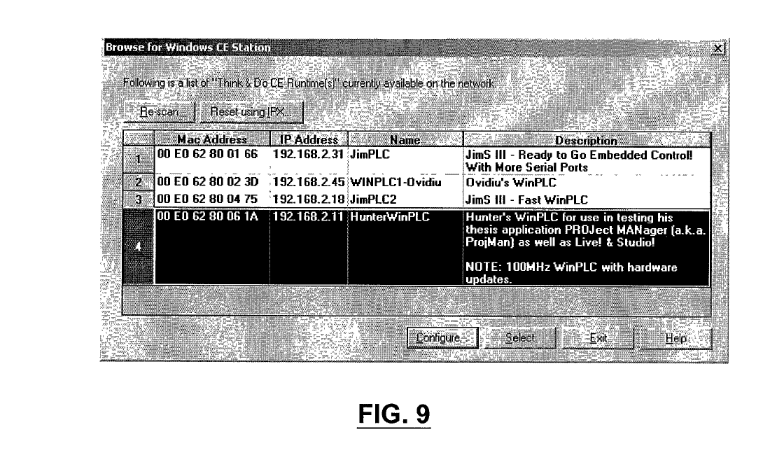

Referring now to FIG. 8, a screen capture of a GUI that identifies the Windows NT/2000 target systems is shown. In FIG. 9, a screen capture of a GUI for identifying the Windows CE based target systems is shown. Once the target systems are discovered, they can be selected and their attributes and properties can be changed. Some of the attributes are control application name, modified date, build date, and other similar or otherwise known attributes. This auto discovery is also useful for supporting remote operator/monitor screens.

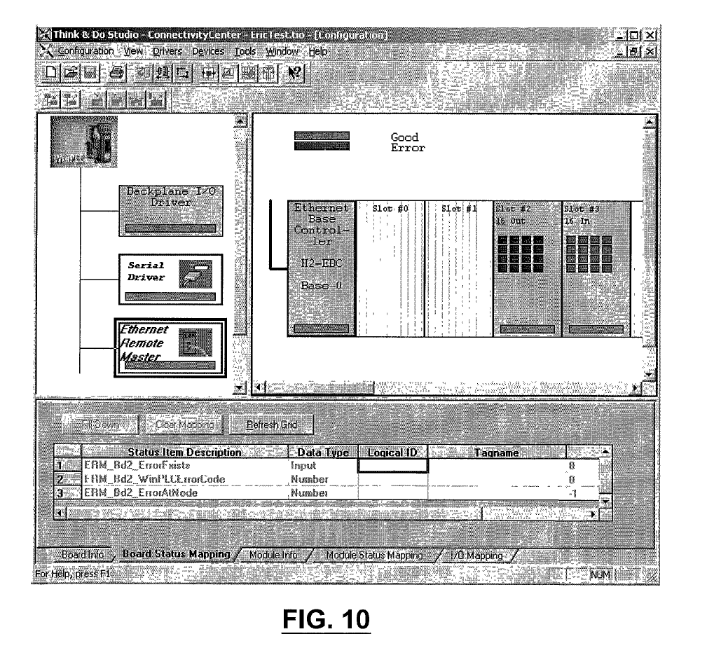

Referring now to FIG. 10, a screen capture shows a GUI for auto discovery for I/O devices. Once the I/O devices have been auto-discovered, the object model enables to clone the devices. The present invention provides a very powerful mechanism to discover the target systems, I/O devices, and clone the devices where industrial automation systems, networks, and devices are configured off-line.

The present invention being thus described, it will be obvious that the same may be varied in many ways. Such variations are not to be regarded as a departure from the spirit and scope of the invention, and all such modifications as would be obvious to one skilled in the art are intended to be included within the scope of the present invention.

What is claimed is:

1. A system for cloning input/output (I/O) devices connected to a network of an industrial control system, comprising:
a first network;
a plurality of I/O devices connected to said first network; and
a master computer coupled to said first network and including control software with an object oriented model for defining one of attributes, parameters and operations of said I/O devices to allow cloning of at least one of said I/O devices.

2. The system of claim 1 wherein said object oriented model includes a hierarchical class structure with inheritance properties.

3. The system of claim 1 wherein said hierarchical class structure includes a device class.

4. The system of claim 3 wherein said device class includes a plurality of device types.

5. The system of claim 4 wherein said object oriented model includes at least one class level hierarchically below said device class.

6. The system of claim 5 wherein devices instantiated at said at least one class level inherit said one of said attributes, parameters and operations of said at least one class level and a device type of said device class from which said at least one class level depends.

7. The system of claim 4 wherein said device types include at least one of analog and digital devices.

8. The system of claim 1 wherein said control software includes a graphical user interface for interfacing said control software and cloning said I/O devices.

9. The system of claim 1 wherein said I/O devices include at least one of barcode readers, sensors, actuators, and motor starters.

10. A system for cloning input/output (I/O) devices connected to a network of an industrial control system, comprising:
a first network;
a second network coupled to said first network;
a first plurality of I/O devices connected to said first network;
a second plurality of I/O devices connected to said second network; and
a master computer coupled to one of said first and second networks and including control software with an object oriented model for defining one of attributes and operations of at least one of said I/O devices on one of said first and second networks to allow cloning of said at least one of said I/O devices to the other of said first and second networks.

11. The system of claim 10 wherein said object oriented model includes a hierarchical class structure with inheritance properties.

12. The system of claim 11 wherein said hierarchical class structure includes a device class.

13. The system of claim 12 wherein said device class includes a plurality of device types.

14. The system of claim 13 wherein said object oriented model includes at least one class level hierarchically below said device class.

15. The system of claim 14 wherein devices instantiated at said at least one class level inherit said one of said attributes and operations of said at least one class level and a device type of said device class from which said at least one class level depends.

16. The system of claim 13 wherein said device types include at least one of analog and digital devices.

17. The system of claim 10 wherein said control software includes a graphical user interface for interfacing said control software and cloning said I/O devices.

18. The system of claim 9 wherein said first and second networks are connected by a gateway.

19. The system of claim 18 wherein said first and second networks are different types of networks.

20. The system of claim 10 wherein said I/O devices connected to said first and second networks include at least one of barcode readers, sensors, actuators, and motor starters.
